(19) United States
(12) Patent Application Publication
(10) Pub. No.: US 2013/0346060 A1
(43) Pub. Date: Dec. 26, 2013

(54) TRANSLATION INTERFACING APPARATUS AND METHOD USING VISION TRACKING

(71) Applicant: Electronics and Telecommunications Research Institute, Daejeon-city (KR)

(72) Inventors: Jong-Hun SHIN, Daejeon (KR); Young-Ae Seo, Daejeon (KR); Seong-II Yang, Daejeon (KR); Jin-Xia Huang, Daejeon (KR); Chang-Hyun Kim, Daejeon (KR); Young-Kll Kim, Daejoen (KR)

(21) Appl. No.: 13/911,489

(22) Filed: Jun. 6, 2013

(30) Foreign Application Priority Data
Jun. 21, 2012 (KR) 10-2012-0066780

(51) Int. Cl. G06F 17/28

(52) U.S. Cl. CPC G06F 17/289
USPC 704/2

(57) ABSTRACT

Disclosed herein are a translation interfacing apparatus and method using vision tracking. The translation interfacing apparatus includes a vision tracking unit, a comparison unit, a sentence detection unit, a sentence translation unit, and a sentence output unit. The vision tracking unit tracks a user's eyes based on one or more images input via the camera of a portable terminal, and extracts time information about a period for which the user's eyes have been fixed and location information about a location on which the user's eyes are focused. The comparison unit compares the time information with a preset eye fixation period. The sentence detection unit detects a sentence corresponding to the location information if the time information is equal to or longer than the eye fixation period. The sentence translation unit translates the detected sentence. The sentence output unit outputs a translated sentence onto the screen of the portable terminal

### CROSS REFERENCE TO RELATED APPLICATION

This application claims the benefit of Korean Patent Application No. 10-2012-0066780, filed on Jun. 21, 2012, which is hereby incorporated by reference in its entirety into this application.

### BACKGROUND OF THE INVENTION

1. Technical Field

The present invention relates generally to a translation interfacing apparatus and method using vision tracking and, more particularly, to a translation interfacing apparatus and method using vision tracking, which can detect a sentence corresponding to a location on which a user's eyes are focused, based on eye information extracted via a camera attached to a portable terminal, and translate the sentence.

2. Description of the Related Art

Recently, a variety of applications using vision tracking (also called eye location tracking) technology have been developed or practiced in a variety of industries, and numerous applications using the same will be presented and used in the future.

Such vision tracking technology may be classified as a method using skin electrodes, a method using contact lenses, or a method based on a remote camera. In order to achieve vision tracking, images are captured using a camera, and the locations and borders of the pupils of a user are recognized. If it is difficult to perform recognition, one of the above methods, such as the method of wearing contact lenses each including a luminous substance that emits light having a specific wavelength, is used, and the locations of the pupils of a user are recognized and the location and fixation time of the user's eyes are extracted, based on the results of the capturing of a camera. Here, the camera captures images in real time, and the location of a user's eyes is detected based on the results of the capturing in real time.

Meanwhile, portable terminals such as mobile phones or smart phones are devices that can be carried and used regardless of place and time. The sizes and weights of portable phones are limited so as to support portability. When an automatic translation system is used on a portable terminal with a small screen, such as that disclosed in Korean Patent No. 10-0634142, the range and type of an output screen should be predetermined and then output should be performed. Otherwise a user experiences inconvenience. Furthermore, the portable terminals are disadvantageous in that long times are required to output the results of translation and the ranges of output content are narrow because the areas of their screens are narrow and the processing speeds of the portable devices are relatively slow.

### SUMMARY OF THE INVENTION

Accordingly, the present invention has been made keeping in mind the above problems occurring in the prior art, and an object of the present invention is to provide a translation interfacing apparatus and method using vision tracking, which can detect a sentence near a location on which a user's eyes are focused based on images input via the camera of a portable terminal using pupil tracking technology and can provide a translated sentence corresponding to the detected sentence, so that a translation service can be provided in real time via the portable terminal which is being carried by an individual, thereby providing more convenience to the user.

In order to accomplish the above object, the present invention provides a translation interfacing apparatus using vision tracking, including a vision tracking unit configured to track a user's eyes based on one or more images input via a camera of a portable terminal, and to extract time information about a period for which the user's eyes have been fixed and location information about a location on which the user's eyes are focused; a comparison unit configured to compare the time information with a preset eye fixation period; a sentence detection unit configured to, if, as a result of the comparison, the time information is equal to or longer than the eye fixation period, detect a sentence corresponding to the location information; a sentence translation unit configured to translate the detected sentence, and to extract a translated sentence; and a sentence output unit configured to output the translated sentence onto the screen of the portable terminal.

The translation interfacing apparatus may further include a setting unit configured to set the eye fixation period.

The setting unit may include a setting checking unit configured to determine whether the eye fixation period has been set; and a setting learning unit configured to perform time setting learning so as to set the eye fixation period.

The setting learning unit may perform the time setting learning if the eye fixation period has not been set or if the preset eye fixation period is set again.

The time setting learning may be performed by presenting a sample sentence to the user and setting a predetermined period for which the user has gazed at the sample sentence as the eye fixation period.

The sentence detection unit may detect the start point of the sentence and the end point of the sentence which ends with a sentence-ending sign.

The sentence output unit may output the translated sentence onto the screen of the portable terminal using a separate layer.

The sentence output unit may output the translated sentence onto the screen of the portable terminal with the translated sentence disposed in front of or behind the detected sentence.

The sentence output unit may output the translated sentence onto the screen of the portable terminal with the detected sentence overwritten with the translated sentence.

In order to accomplish the above object, the present invention provides a translation interfacing method using vision tracking, including tracking a user's eyes based on one or more images input via a camera of a portable terminal, and extracting time information about a period for which the user's eyes have been fixed and location information about a location on which the user's eyes are focused; comparing the time information with a preset eye fixation period; if, as a result of the comparison, the time information is equal to or longer than the eye fixation period, detecting a sentence corresponding to the location information; extracting a translated sentence obtained by translating the detected sentence; and outputting the translated sentence onto the screen of the portable terminal

The translation interfacing method may further include, before the tracking a user's eyes based on one or more images, setting the eye fixation period.

The setting the eye fixation period may include determining whether the eye fixation period has been set; and performing time setting learning so as to set the eye fixation period.

The performing time setting learning may include performing the time setting learning if the eye fixation period has not been set or if the preset eye fixation period is set again.

The performing time setting learning may include presenting a sample sentence to the user and then setting a predetermined period for which the user has gazed at the sample sentence as the eye fixation period.

The detecting a sentence corresponding to the location information may include detecting the start point of the sentence and the end point of the sentence which ends with a sentence-ending sign.

The outputting the translated sentence onto the screen of the portable terminal may include outputting the translated sentence onto the screen of the portable terminal using a separate layer.

The outputting the translated sentence onto the screen of the portable terminal may include outputting the translated sentence onto the screen of the portable terminal with the translated sentence disposed in front of or behind the detected sentence.

The outputting the translated sentence onto the screen of the portable terminal may include outputting the translated sentence onto the screen of the portable terminal with the detected sentence overwritten with the translated sentence.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a portable terminal including a translation interfacing apparatus using vision tracking according to an embodiment of the present invention;

FIG. 2 is a block diagram showing the configuration of the translation interfacing apparatus using vision tracking according to the embodiment of the present invention;

FIG. 3 is a diagram illustrating the sequence of a translation interfacing method using vision tracking according to an embodiment of the present invention;

FIG. 4 is a diagram illustrating a method of detecting a sentence near a location corresponding to location information regarding a user's eyes in the translation interfacing method using vision tracking according to the embodiment of the present invention; and

FIGS. 5 to 7 are diagrams illustrating specific methods of outputting an extracted, translated sentence onto the screen of a portable terminal in the translation interfacing method using vision tracking according to the embodiment of the present invention.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary knowledge in the art. Accordingly, the shapes, sizes, etc. of elements in the drawings may be exaggerated to make the description clear.

A translation interfacing apparatus and method using vision tracking according to embodiments of the present invention will be described in detail below with reference to the accompanying drawings.

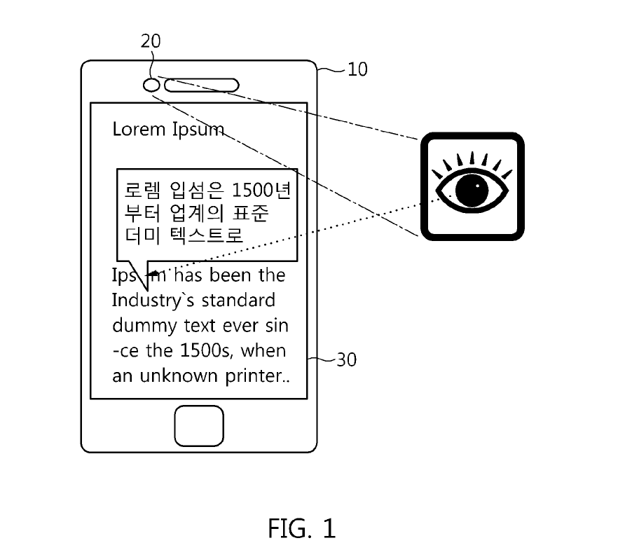

FIG. 1 is a diagram showing a portable terminal including a translation interfacing apparatus using vision tracking according to an embodiment of the present invention.

Referring to FIG. 1, the translation interfacing apparatus using vision tracking technology included in the portable terminal 10 provides an interface that tracks a user's eyes based on images input via a camera 20 installed in the front of the portable terminal 10, detects the boundary of a sentence within the screen 30 of the portable terminal, corresponding to a location on which the user's eyes are focused, based on the results of the tracking, transfers information about the boundary to an automatic translation engine, and outputs an extracted translated sentence onto the screen 30 of the portable terminal

Here, the vision tracking according to the present invention is a method of capturing the user's eyes using the camera 20 and determining the direction in which eyeballs are directed. The user's eyes and view are captured using the subminiature camera 20, and the locations of the pupils and the location of reflected light are determined through image analysis, thereby measuring the direction in which eyeballs are directed. This method is advantageous in that the size of the camera used in this method is small and the location of measurement is not limited. That is, measurements can be made outside of a laboratory while a user is walking across a shopping center or an outdoor area or is driving a car. Furthermore, momentary changes in sentiment or concentration can be detected by measuring the enlargement/constriction of the pupils and the number of blinks as well as the direction of the eyes.

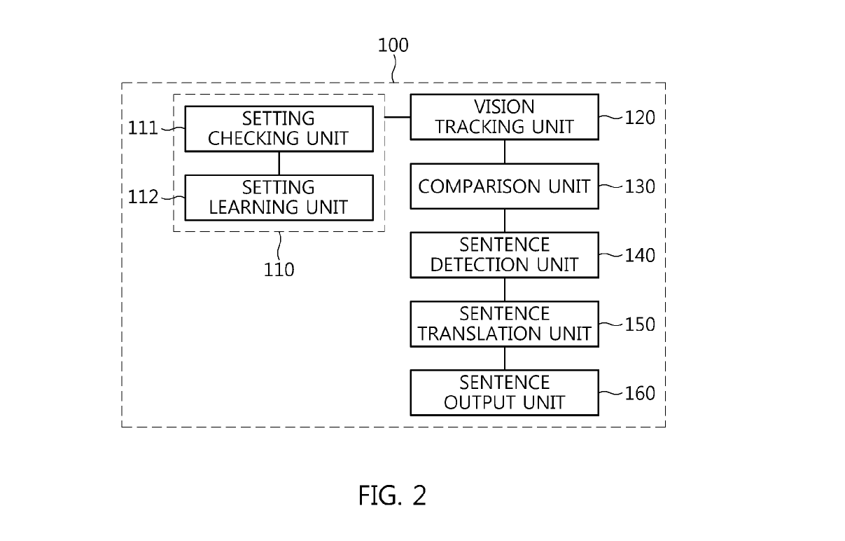

FIG. 2 is a block diagram showing the configuration of the translation interfacing apparatus using vision tracking according to the embodiment of the present invention.

Referring to FIG. 2, the translation interfacing apparatus 100 using vision tracking includes a setting unit 110, a vision tracking unit 120, a comparison unit 130, a sentence detection unit 140, a sentence translation unit 150, and a sentence output unit 160.

The setting unit 110 may be configured to set an eye fixation period that is used to allow a sentence, corresponding to a location on which the user's eyes are focused, to be translated based on the fact that the user's eyes are fixed in a period equal to or longer than the eye fixation period.

For this purpose, the setting unit 110 may include a setting checking unit 111 and a setting learning unit 112. The setting checking unit 111 determines whether an eye fixation period has been set, and the setting learning unit 112 performs time setting learning to set an eye fixation period.

In greater detail, when the user starts to use the interface using the portable terminal 10, the setting checking unit 111 determines whether there is a preset eye fixation period. In this case, if there is a preset eye fixation period, the eye information obtained by tracking the user's eyes based on images input through the camera 20 of the portable terminal 10 is caused to be extracted by the vision tracking unit 120. Meanwhile, if there is no preset eye fixation period, an eye fixation period is set by performing time setting learning via the setting learning unit 112. In this case, the setting learning unit 112 may perform time setting learning in the case in which the preset eye fixation period is set again, as well as in the case in which the eye fixation period is not set as described above.

Here, the time setting learning may be performed using the following method. That is, a user is asked whether he or she intends to translate a sample sentence or a document including a plurality of sample sentences when the user has gazed at a point for a period equal to or longer than a predetermined period, for example, 0.5 seconds, after the sample sentence or document was presented to the user. In this case, if the user selects “YES,” settings are made such that the sentence is translated in response to the predetermined time (=0.5 seconds), and then the learning is terminated If the user selects “NO,” the user is asked the same question when the user has gazed at a point for a period equal to or longer than a predetermined period, for example, the existing 0.5 seconds plus 0.5 seconds. Through this process, a predetermined period for which the user's eyes have been fixed is set as the eye fixation period, and the interface is set such that the interface determines whether a sentence corresponding to a location on which the user's eyes are focused is a sentence that is desired to be translated by the user based on the eye fixation period. Here, the set eye fixation period may be converted into a value in units of milliseconds (ms) via an additional interface.

The vision tracking unit 120 may extract eye information by tracking the user's eyes based on images input via the camera 20 of the portable terminal 10. Here, the eye information includes time information about a period for which the user's eyes are fixed and location information about a location on which the user's eyes are focused. That is, the vision tracking unit 120 recognizes the user's eyes after the camera 20 has captured images, and extracts time information and location information regarding the user's eyes.

The comparison unit 130 may compare the time information with the preset eye fixation period. The comparison unit 130 determines that the user's eyes have been sufficiently fixed if the time information is equal to or longer than the eye fixation period preset by the setting unit 110 as described above, and determines that the user's eyes have not been sufficiently fixed if the time information is shorter than the preset eye fixation period.

The sentence detection unit 140 detects a sentence corresponding to the location information if, as a result of the comparison, it is determined that the time information corresponds to the eye fixation period. Here, the sentence detection unit 140 detects the borders of a sentence on which the user's eyes are focused, that is, the start point of the sentence and the end point which ends with a sentence-ending mark such as a punctuation mark. Here, before the screen of the portable terminal 30 is output, text is segmented in advance and used to determine the borders of a sentence.

The sentence translation unit 150 may extract a translated sentence by translating the detected sentence. That is, the sentence translation unit 150 transfers the detected sentence to a separate automatic translation engine, and then extracts a corresponding translated sentence.

The sentence output unit 160 may output the extracted translated sentence onto the screen 30 of the portable terminal Here, methods of representing the translated sentence on the screen 30 of the portable terminal may be classified into the following three types of methods, but are not limited thereto. First, the translated sentence may be output onto the screen 30 of the portable terminal using a separate layer. Here, the layer may be located above or below the detected sentence so that the layer does not overlap or partially overlaps the detected sentence. The location of the layer may be changed by the manipulation of the user. Second, the translated sentence may be output onto the screen 30 of the portable terminal with the translated sentence disposed in front of or behind the detected sentence. That is, the translated sentence may be displayed with the translated sentence added in front of or behind the detected sentence. Third, the translated sentence may be output onto the screen 30 of the portable terminal with the detected sentence overwritten with the translated sentence. Here, the detected sentence is covered and hidden by the translated sentence.

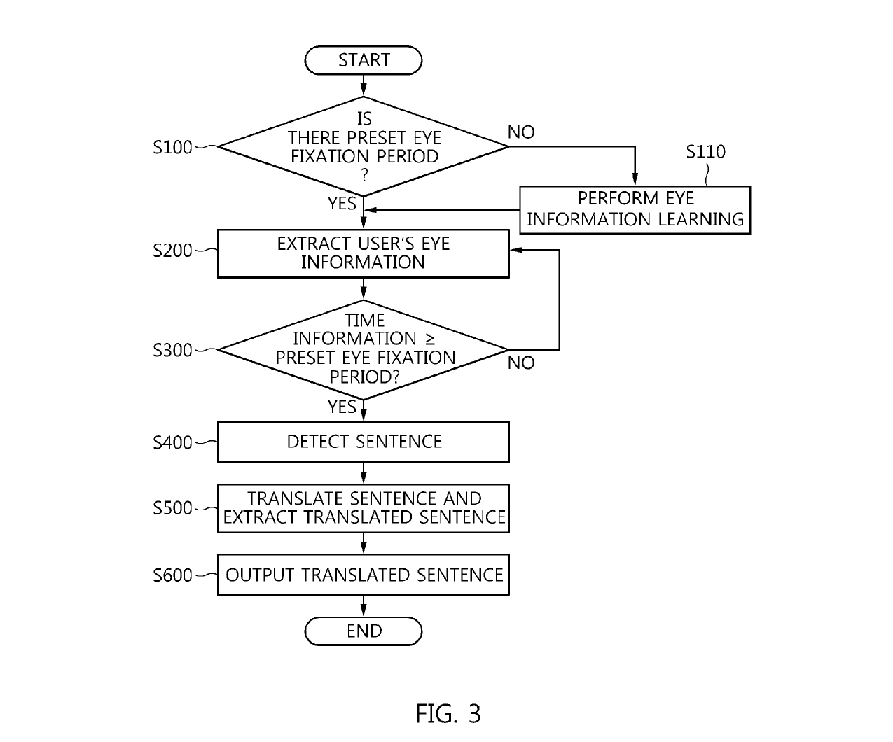

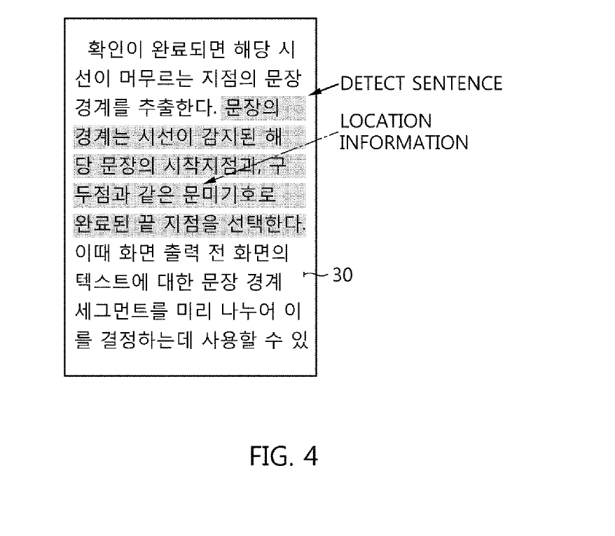

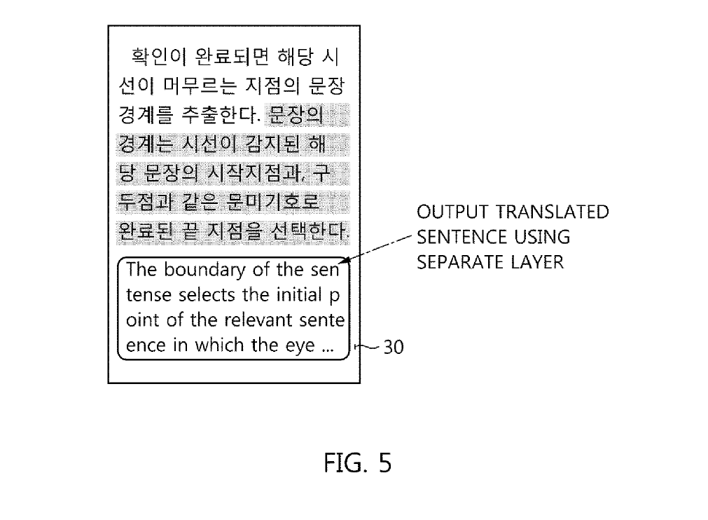

FIG. 3 is a diagram illustrating the sequence of a translation interfacing method using vision tracking according to an embodiment of the present invention, FIG. 4 is a diagram illustrating a method of detecting a sentence near a location corresponding to location information regarding a user's eyes in the translation interfacing method using vision tracking according to the embodiment of the present invention, and FIGS. 5 to 7 are diagrams illustrating specific methods of outputting an extracted, translated sentence onto the screen of a portable terminal in the translation interfacing method using vision tracking according to the embodiment of the present invention.

Referring to FIG. 3, in the translation interfacing method using vision tracking, when a user uses an interface, an eye fixation period is set such that a sentence corresponding to a location on which the user's eyes are focused is translated based on the fact that the user's eyes have been fixed for a specific period equal to or longer than the eye fixation period. First of all, it is determined whether a preset eye fixation period has been set at step S100. If the eye fixation period has not been set, time setting learning is performed at step S110. Here, the time setting learning is performed in such a way that the user is asked whether he or she intends to translate a sample sentence or a document including a plurality of sample sentences when the user has gazed at a point for a period equal to or longer than a predetermined period after the sample sentence or the document was presented to the user. In this case, if the user selects “YES,” settings are made such that the sentence is translated in response to the predetermined time, and then the learning is terminated. If the user selects “NO,” the user is asked the same question when the user has gazed at a point for a period equal to or longer than the existing period plus an additional period. Through this process, a predetermined period for which the user's eyes have been fixed is set as the eye fixation period, and the interface is set such that the interface determines whether a sentence corresponding to a location on which the user's eyes are focused is a sentence that is desired to be translated by the user based on the eye fixation period.

Thereafter, the user's eye information is extracted from images input through the camera 20 of the portable terminal 10 at step S200. Here, the eye information includes time information about a period for which the user's eyes are fixed and location information about a location on which the user's eyes are focused.

Thereafter, the time information is compared with the preset eye fixation period at step S300. If the time information is equal to or longer than the preset eye fixation period, it is determined that the user's eyes have been sufficiently fixed; if the time information is shorter than the preset eye fixation period, it is determined that the user's eyes have not been sufficiently fixed.

Thereafter, if, as a result of the comparison, it is determined that the time information is equal to or longer than the eye fixation period, a sentence placed at a location corresponding to the location information is detected at step S400, as shown in FIG. 4. Here, the borders of a sentence on which the user's eyes are focused, that is, the start point of the sentence and the end point thereof which ends with a sentence-ending mark such as a punctuation mark, are detected.

Thereafter, a translated sentence obtained by translating the detected sentence is extracted at step S500. In this case, the detected sentence is transferred to the separate automatic translation engine, and then a corresponding translated sentence is extracted.

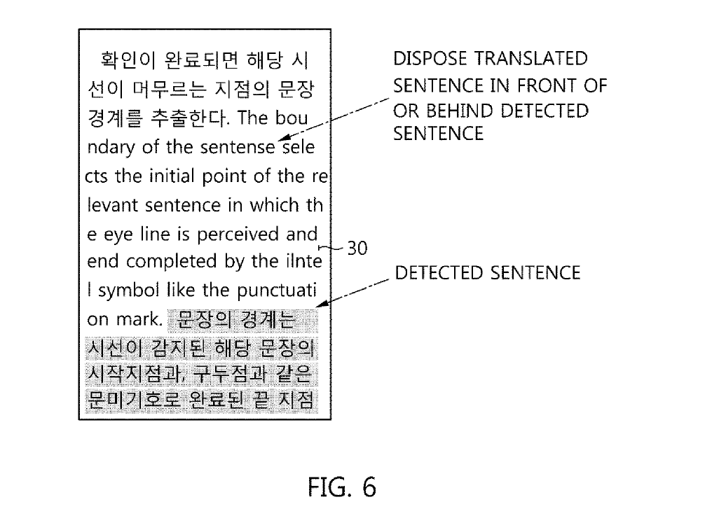

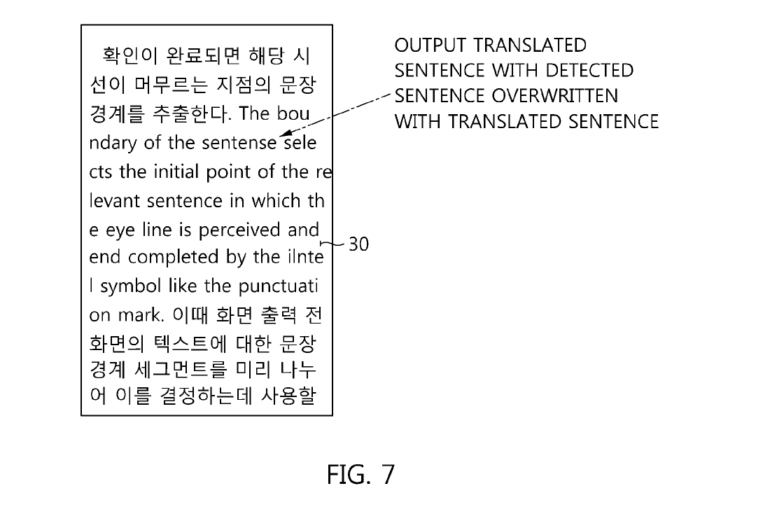

Thereafter, the translated sentence is output onto the screen of the portable terminal at step S600. Here, methods of representing the translated sentence on the screen 30 of the portable terminal may be classified into the following three types of methods, but are not limited thereto. First, the translated sentence may be output onto the screen 30 of the portable terminal using a separate layer, as shown in FIG. 5. Here, the layer may be located above or below the detected sentence so that the layer does not overlap or partially overlaps the detected sentence. The location of the layer may be changed by the manipulation of the user. Second, the translated sentence may be output onto the screen 30 of the portable terminal with the translated sentence disposed in front of or behind the detected sentence, as shown in FIG. 6. Third, the translated sentence may be output onto the screen 30 of the portable terminal with the detected sentence overwritten with the translated sentence, as shown in FIG. 7.

The present invention is advantageous in that the translation interfacing apparatus and method using vision tracking can detect a sentence near a location on which a user's eyes are focused based on images input via the camera of a portable terminal using pupil tracking technology and provide a translated sentence corresponding to the detected sentence, so that a translation service can be provided in real time via the portable terminal which is being carried by an individual, thereby providing more convenience for the user.

Furthermore, the present invention is advantageous in that the translation interfacing apparatus and method using vision tracking can track the user's eyes using the camera of the portable terminal and provide the results of the translation of a sentence desired by the user, so that a translation can be used without requiring the user's separate manipulation, thereby providing more convenience to the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A translation interfacing apparatus using vision tracking, comprising:
a vision tracking unit configured to track a user's eyes based on one or more images input via a camera of a portable terminal, and to extract time information about a period for which the user's eyes have been fixed and location information about a location on which the user's eyes are focused;
a comparison unit configured to compare the time information with a preset eye fixation period;
a sentence detection unit configured to, if, as a result of the comparison, the time information is equal to or longer than the eye fixation period, detect a sentence corresponding to the location information;
a sentence translation unit configured to translate the detected sentence, and to extract a translated sentence; and
a sentence output unit configured to output the translated sentence onto a screen of the portable terminal.

2. The translation interfacing apparatus of claim 1, further comprising a setting unit configured to set the eye fixation period.

3. The translation interfacing apparatus of claim 2, wherein the setting unit comprises:
a setting checking unit configured to determine whether the eye fixation period has been set; and
a setting learning unit configured to perform time setting learning so as to set the eye fixation period.

4. The translation interfacing apparatus of claim 3, wherein the setting learning unit performs the time setting learning if the eye fixation period has not been set or if the preset eye fixation period is set again.

5. The translation interfacing apparatus of claim 3, wherein the time setting learning is performed by presenting a sample sentence to the user and setting a predetermined period for which the user has gazed at the sample sentence as the eye fixation period.

6. The translation interfacing apparatus of claim 1, wherein the sentence detection unit detects a start point of the sentence and an end point of the sentence which ends with a sentence-ending sign.

7. The translation interfacing apparatus of claim 1, wherein the sentence output unit outputs the translated sentence onto the screen of the portable terminal using a separate layer.

8. The translation interfacing apparatus of claim 1, wherein the sentence output unit outputs the translated sentence onto the screen of the portable terminal with the translated sentence disposed in front of or behind the detected sentence.

9. The translation interfacing apparatus of claim 1, wherein the sentence output unit outputs the translated sentence onto the screen of the portable terminal with the detected sentence overwritten with the translated sentence.

10. A translation interfacing method using vision tracking, comprising:
tracking a user's eyes based on one or more images input via a camera of a portable terminal, and extracting time information about a period for which the user's eyes have been fixed and location information about a location on which the user's eyes are focused;
comparing the time information with a preset eye fixation period;
if, as a result of the comparison, the time information is equal to or longer than the eye fixation period, detecting a sentence corresponding to the location information;
extracting a translated sentence obtained by translating the detected sentence; and
outputting the translated sentence onto a screen of the portable terminal

11. The translation interfacing method of claim 10, further comprising, before the tracking a user's eyes based on one or more images, setting the eye fixation period.

12. The translation interfacing method of claim 11, wherein the setting the eye fixation period comprises:
determining whether the eye fixation period has been set; and
performing time setting learning so as to set the eye fixation period.

13. The translation interfacing method of claim 12, wherein the performing time setting learning comprises performing the time setting learning if the eye fixation period has not been set or if the preset eye fixation period is set again.

14. The translation interfacing method of claim 12, wherein the performing time setting learning comprises presenting a sample sentence to the user and then setting a predetermined period for which the user has gazed at the sample sentence as the eye fixation period.

15. The translation interfacing method of claim 10, wherein the detecting a sentence corresponding to the location information comprises detecting a start point of the sentence and an end point of the sentence which ends with a sentence-ending sign.

16. The translation interfacing method of claim 10, wherein the outputting the translated sentence onto the screen of the portable terminal comprises outputting the translated sentence onto the screen of the portable terminal using a separate layer.

17. The translation interfacing method of claim 10, wherein the outputting the translated sentence onto the screen of the portable terminal comprises outputting the translated sentence onto the screen of the portable terminal with the translated sentence disposed in front of or behind the detected sentence.

18. The translation interfacing method of claim 10, wherein the outputting the translated sentence onto the screen of the portable terminal comprises outputting the translated sentence onto the screen of the portable terminal with the detected sentence overwritten with the translated sentence.
